(19) United States
(12) Patent Application Publication
(10) Pub. No.: US 2008/0285422 A1
(43) Pub. Date: Nov. 20, 2008

(54) OBJECTIVE LENS AND OPTICAL PICKUP APPARATUS

(76) Inventor: Kunihiko TAKA, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/119,858

(22) Filed: May 13, 2008

(30) Foreign Application Priority Data
May 14, 2007 (JP) 2007-127954

(51) Int. Cl. G11B 7/135

(52) U.S. Cl. 369/112.23

(57) ABSTRACT

Disclosed is an objective lens for an optical pickup apparatus which records and/or reproduces information with a light beam emitted from a light source, including: a substrate; and an anti-reflection coating comprising at least one layer, formed on a surface of the substrate at a side of the light source, wherein a refractive index of the anti-reflection coating at a peripheral part where an outer edge of an effective light beam transmits is smaller than a refractive index of the anti-reflection coating at a center part where a light beam on an optical axis transmits.

### BACKGROUND OF THE INVENTION

1. Field of the Invention

The present invention relates to an optical pickup apparatus to record and/or reproduce information by a beam of light emitted from a light source, and an objective lens for the optical pickup apparatus.

2. Description of Related Art

Recently, the recording density of the optical pickup apparatuses have been getting higher, and thus numeric aperture of the optical elements such as objective lenses have been getting larger and wavelength of the laser light has been getting shorter. Larger numeric aperture causes larger curvature of an objective lens, which results larger incident angle of a laser beam at a peripheral part of the objective lens. For example, an optical pick up apparatus using laser light of nm wavelength has an objective lens of numeric aperture as large as 0.6 to 0.9, and the largest incident angle of the laser light to the objective lens is 50 to 70°.

Since larger incident angle causes larger reflection of laser light at a peripheral part of an objective lens, the amount of transmitted light at the peripheral part decreases, and thereby a signal-to-noise ratio (S/N ratio) in signal reproduction decreases. To cope with this problem, recent objective lenses are provided with antireflection coating to expand low-reflection band, so as to reduce the decrease of transmittance at peripheral parts of the objective lenses (for example, see Japanese patent application publication laid-open No. H10-160906).

However, multi-layered antireflection coating to achieve more effective expansion of the low-reflection band results higher production cost.

### SUMMARY

It is one of objects of the present invention to provide an objective lens having improved total transmittance while the production cost thereof is kept low, and to provide an optical pickup apparatus provided with the objective lens.

In order to solve the above problem, according to a first aspect of the present invention, an objective lens for an optical pickup apparatus which records and/or reproduces information with a light beam emitted from a light source, comprises: a substrate; and an anti-reflection coating comprising at least one layer, formed on a surface of the substrate at a side of the light source, wherein a refractive index of the anti-reflection coating at a peripheral part where an outer edge of an effective light beam transmits is smaller than a refractive index of the anti-reflection coating at a center part where a light beam on an optical axis transmits.

By the above feature, it becomes possible to suppress reflection at the peripheral part of the objective lens having large curvature while the number of layers of the antireflection coating and the resulting production cost are kept as low as before.

According to a second aspect of the invention, an objective lens for an optical pickup apparatus which records and/or reproduces information with a light beam emitted from a light source, comprises: a substrate; and an anti-reflection coating comprising at least one layer, formed on a surface of the substrate at a side of the light source, wherein a packing density of the anti-reflection coating at a peripheral part where an outer edge of an effective light beam transmits is smaller than a packing density of the anti-reflection coating at a center part where a light beam on an optical axis transmits.

Preferably, a wavelength X of the light beam emitted from the light source is within a range of 350 nm≦λ≦450 nm.

Preferably, the objective lens has a numeral aperture of 0.6 to 0.9 inclusive.

Preferably, the objective lens has a numeral aperture of 0.8 to 0.9 inclusive.

Preferably, an angle between a normal line of a surface at the peripheral part and the optical axis is 48° to 72° inclusive.

Preferably, the angle between the normal line of the surface at the peripheral part and the optical axis is 60° to 72° inclusive.

Preferably, the anti-reflection coating is composed of one to three layers.

Preferably, at least one layer of the anti-reflection coating is formed of a low-refractive index material having a refractive index n of 1.3≦n≦1.5 for a light of 500 nm wavelength.

Preferably, the low-refractive index material is SiO₂-based material.

Preferably, the refractive index at the peripheral part is 0.8 to 0.98 times inclusive of the refractive index at the center part.

Preferably, the refractive index at the peripheral part is 0.85 to 0.92 times inclusive of the refractive index at the center part.

Preferably, the packing density at the peripheral part is 0.38 to 0.94 times inclusive of the packing density at the center part.

Preferably, the packing density at the peripheral part is 0.53 to 0.75 times inclusive of the packing density at the center part.

Preferably, the substrate is formed of a plastic material.

According to a third aspect of the present invention, an optical pickup apparatus comprises the objective lens of the first or second aspect.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a conceptual view showing a schematic configuration of an optical pickup apparatus of the present embodiment;

FIG. 2 is a side view showing an objective lens of the present embodiment;

FIG. 3 is a conceptual view showing a schematic configuration of a vacuum vapor deposition device;

FIG. 4 shows a method to fix a lens substrate in the vacuum vapor deposition device;

FIG. 5 shows reflectance characteristics of related art; and

FIG. 6 shows reflectance characteristics of the present embodiment.

### DETAILED DESCRIPTION OF PREFERRED EMBODIMENTS

Hereinafter, embodiments of the present invention will be described with reference to the drawings.

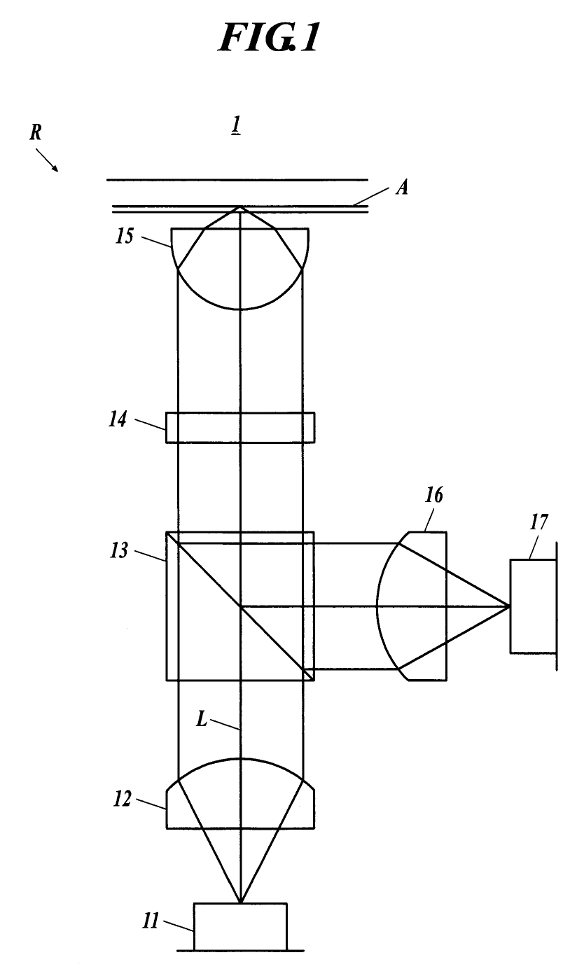

FIG. 1 is a conceptual view showing a schematic configuration of an optical pickup apparatus 1 of the present embodiment.

As shown in this figure, the optical pickup apparatus 1 comprises a laser diode 1, and is to record information onto an information recording surface A of an information recording medium R and to read and reproduce information recorded on the information recording surface A. As the information recording medium R, a BD (Blu-ray disk), HD-DVD or the like can be given. In the present embodiment, the information recording medium R is a BD. Further, the information recording medium R has a protective layer of 0.1 mm thickness.

The laser diode 11 is a laser source of the present embodiment, and emits laser light of wavelength λ1 (350≦λ1≦450 nm) at the time of recording/reproducing information with the information recording medium R. In the embodiment, wavelength λ1 is 405 nm.

A collimator lens 12, a polarization beam splitter 13, a quarter wavelength plate 14, and an objective lens 15 are disposed in alignment in a direction from bottom to top in FIG. 1, which is an optical axis L of a laser beam emitted from the laser diode 11. The objective lens 15 is provided with a two-dimensional actuator (not shown) to shift the objective lens 15 in the vertical direction of FIG. 1. The information recording medium R is to be mounted at a position opposing the objective lens 15.

Accompanied with the polarization beam splitter 13, a convex lens 16 and an optical detector 17 are mounted in alignment on the right side in FIG. 1.

Next, operation and action of the optical pickup apparatus 1 will be briefly described.

At the time of recording information onto the information recording medium R and reproducing information in the information recording medium R, the laser diode 11 emits laser light of wavelength λ1. The laser light is firstly converted into parallel light by the collimator lens 12, and thereafter the polarization beam splitter 13 lets only P-polarization component of the light transmit so as to convert the light into linear polarized light (P-polarized light).

Next, this P-polarized laser light is converted into right-hand circularly polarized light by the quarter wavelength plate 14, and thereafter is focused by the objective lens 15, enters on the information recording surface A of the information recording medium R at various incident angles, and forms a focused spot. The objective lens 15 also performs focusing and tracking by means of the two-dimensional actuator disposed around the lens.

Next, the laser light, which is circularly polarized light and forms the focused spot, is reflected on the information recording surface A of the information recording medium R and thereby converted into left-hand circularly polarized light. The reflected laser light then passes through the objective lens 15 again, and is converted into linear polarized light composed of a S-polarized component only (S-polarized light). Next, this S-polarized laser light is totally reflected by the polarization beam splitter 13, and is focused to the optical detector 17 by the convex lens 16. The information in the information recording medium R is reproduced by using output signal of the optical detector 17.

Next, configuration of the objective lens 15 will be described.

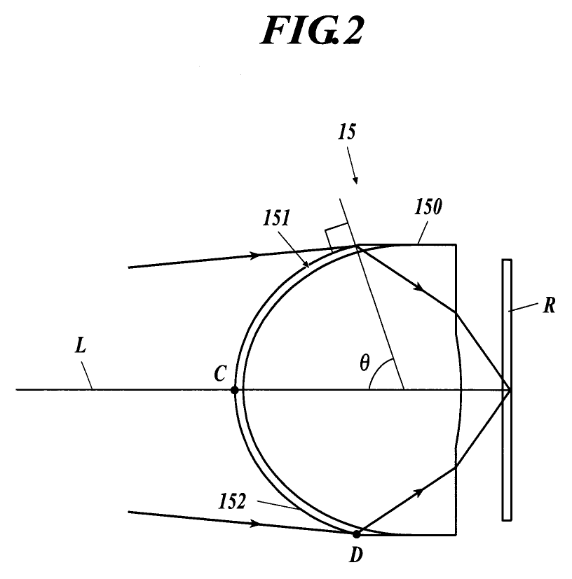

The objective lens 15 is an optical element of the present invention, and as shown in FIG. 2, is a single lens having one substrate 150 in the present embodiment. The objective lens 15 has large curvature and also large numeric aperture (NA). In the present embodiment, the NA is 0.55≦NA≦0.9.

Two optical surfaces of the substrate 150 of the present embodiment are both aspherical. The optical surfaces may have diffraction structures known in the art.

The substrate 150 is formed of plastic material having superior resistance to short wavelength blue-violet laser and superior heat resistance. For such plastic material, a resin composition comprising a copolymer resin of α-olefin and cyclic olefin and a light-resistance stabilizer, or the like can be given.

Anti-reflection coating is provided on a surface of the substrate 150 to form an optically functional surface, at a side of the light source, i.e. at an incident side in FIG. 2. The number of layers of the anti-reflection coating is not limited, but preferably one to three layers.

The anti-reflection coating 151 is formed such that a ratio Rₙ=n_{D}/n_{C} fulfills Rₙ<1.0, where n_{D} is refractive index at a peripheral part D where an outer edge of an effective light beam transmits, and n_{C} is refractive index at a center part C where a light beam on the light axis transmits. The peripheral part D locates at a position corresponding to an open angle of light axis and light beam which define NA.

The anti-reflection coating 151 is formed such that a ratio R_{P}=P_{D}/P_{C} fulfills R_{P}<1.0, where P_{D} is packing density at the peripheral part D, and P_{C} is packing density at the center part C.

The packing density is a substantial volume of a coating divided by a sum of the substantial volume and pore volume of the coating, and for example, is calculated from the following formula by utilizing absorption of vapor at wavelength of 2.97 μm, as described in “Optical coating and coating technique” by Li Zheng zhong, translated by Ulvac, Inc. and issued by Agne Gijutsu Center Co., Ltd. which is incorporated by reference.

$$P = 1 - \frac{ln ( {T}_{o} / T )}{{α}_{w} {d}_{f}}$$

where: P is packing density; T₀ is transmittance when vapor is fully absorbed in vacuum; T is transmittance when vapor is fully absorbed in air; α_{W} is absorption coefficient of water (=1.27×10⁻⁴ cm⁻¹) ; and d_{f} is thickness of coating (cm).

At least one layer of the anti-reflection coating 151 is formed of low refractive index material having refractive index n for light of 500 nm wavelength of 1.3≦n≦1.55.

It is particularly preferable the low refractive index material is SiO₂-based material.

Such anti-reflection coating 151 may be formed by means of vapor deposition, sputtering, CVD, application or the like. In the present embodiment, vacuum vapor deposition is employed. The method of the employed vapor deposition will be summarized. The objective lens 15 of the invention is not limited to the one made by the following method.

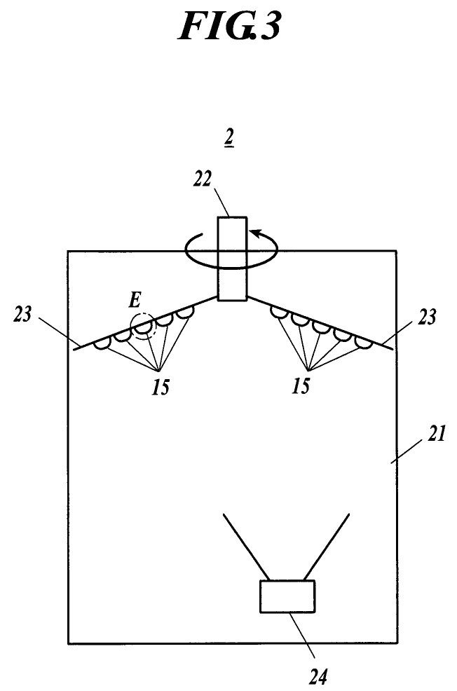

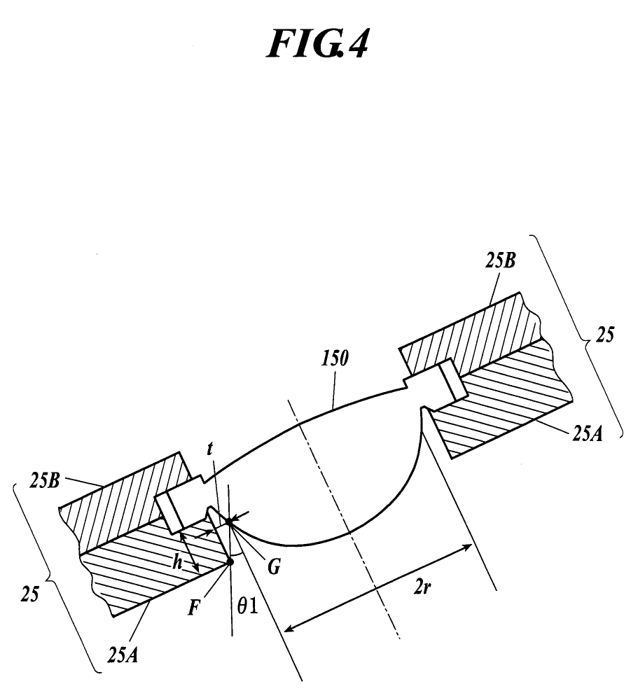

FIG. 3 shows a schematic configuration of the vacuum vapor deposition device. In the figure, a vacuum vapor deposition device 2 comprises a vacuum chamber 21, a rotation shaft 22 disposed rotatably on a ceiling of the vacuum chamber, a rotation plate 23 fixed on the rotation shaft 22, a crucible 24 disposed at a position below the rotation plate 23 slightly displaced from the center of the vacuum chamber 21 to the side wall thereof. A plurality of substrates 150 are to be disposed on a back surface of the rotation plate 23 via holding members 25 (see FIG. 4).

FIG. 4 shows a schematic view of the substrate 150 attached to the holding member 25 (enlarged view of portion E in FIG. 3). The holding member 25 comprises plate-shaped members 25A and 25B, and the substrate 150 is fixed at entire circumference of the peripheral flange portion in the axis direction by the plate-shaped members 25A and 25B. The plate-shaped members 25A and 25B are detachably attached to the rotation plate 23 so that the substrate 150 is attached to the rotation plate 23.

At the time of vapor deposition, a plurality of substrates 150 are attached to the rotation plate 23 in a manner that the surfaces to be subjected to deposition face downward. While the substrates 150 are rotated by the rotation shaft 22 via the rotation plate 23, vapor deposition material is evaporated from the crucible 24 to deposit onto the deposited surfaces of the substrates 150.

According to the above-described vacuum vapor deposition device 2, refractive index n at the peripheral part D of the anti-reflection coating 151 to be formed can be controllably changed by changing an angle θ1 of a line between a peripheral part G of the substrate 150, which corresponds to the peripheral part D of the anti-reflection coating 151, and a tip F of the plate-shaped member 25A with respect to the optical axis of the parallel light (see FIG. 4). Instead of θ1, the refractive index n at the peripheral part D of the anti-reflection coating 151 can be changed similarly by changing distance t between the peripheral part G of the substrate 150 and the plate-shaped member 25A or thickness h of the plate-shaped member 25A.

Table 1 shows refractive indexes n at the center part C and peripheral part D and a ratio of the peripheral part D to the central part C with respect to each of three values of θ1 in the case of SiO2 single layer. According to the table, refractive index n at the peripheral part D can be increased by increasing θ1 while leaving refractive index n at the central part C to be constant.

TABLE 1

| | (1) n AT CENTER | (2) PERIPHERAL | (3) PERIPHERAL | | |
|---|---|---|---|---|---|
| θ1 | PART | PART (NA = 0.6) | PART (NA = 0.85) | (2)/(1) | (3)/(1) |
| 30 | 1.46 | 1.36 | 1.28 | 0.93 | 0.87 |
| 45 | 1.46 | 1.40 | 1.36 | 0.97 | 0.92 |
| 60 | 1.46 | 1.44 | 1.40 | 0.99 | 0.96 |

An undercoat layer known in the art may be intermediated between the substrate 150 and anti-reflection coating 151 to improve adhesion of the anti-reflection coating 151 onto the substrate 150. Further, the anti-reflection coating 151 may be provided with an antifouling layer, a water-shedding layer, and an antistatic layer in the surface side thereof to prevent adhesion of dust etc. due to static electricity.

### EXAMPLE 1

Hereinafter, the present invention will be described in more detail by giving examples and comparative examples.

<Configuration of Objective Lens>

As for the examples of the objective lens 15 of the present invention, five types of the lens substrate 150 each having different NA as shown in the following table 2 were prepared and the anti-reflection coating 151 composed of three layers as shown in Table 3 was formed on an incident surface of each substrate. As for shape of the substrate 150, one known in the art was employed.

As for the anti-reflection coating 151, five types of examples which have ratio Rₙ of refractive index n at the peripheral part D to refractive index n at the center part C within a range from 0.8 to 0.98, and additionally, one comparative example of Rₙ=1 known in the art, thus six types in total, were formed (see Table 4).

The “plane angle” in Table 2 represents an angle θ in FIG. 2 between normal line of a plane of the anti-reflection coating 151 at the peripheral part D where an outer edge of the effective beam of light transmits and the light axis. In Table 3, the layer having smaller layer No. (thinner thickness) is more close to the substrate 150. Also as shown in Table 3, only ZrO2 was used as material mixed with SiO2 of low refractive index material. However, the other high refractive index material having refractive index of 1.8≦n≦2.5 may be used such as hafnium oxide, yttrium oxide, lanthanum oxide, tantalum oxide, etc.

The coating was formed by vacuum vapor deposition. In the present example, precision vacuum thin film deposition device ACE-1350 produced by Shincron Co., Ltd. was used as the vacuum vapor deposition device 2.

TABLE 2

| SUBSTRATE NO. | NA | PLANE ANGLE |
|---|---|---|
| SUBSTRATE (1) | 0.9 | 72 |
| SUBSTRATE (2) | 0.85 | 68 |
| SUBSTRATE (3) | 0.8 | 60 |
| SUBSTRATE (4) | 0.6 | 48 |
| SUBSTRATE (5) | 0.55 | 45 |

TABLE 3

| | | PHYSICAL THICKNESS AT |
|---|---|---|
| LAYER NO. | MATERIAL | CENTER OF LENS (nm) |
| (1) | SiO₂ | 16 |
| (2) | ZrO₂ | 30 |
| (3) | SiO₂ | 106 |

<Evaluation of Transmittance>

Each of the examples of the objective lens 15, where the lens substrate 150 shown in Table 2 was coated with the anti-reflection coating 151 shown in Table 3 at the incident surface thereof, was measured for transmittance of overall lens. The result of the measurement is shown in an area framed by bold lines of Table 4. In the table, the results are associated with the ratio Rₙ of the refractive index n at the peripheral part D to the refractive index n at the center part C and the corresponding ratio R_{P} of the packing density P.

TABLE 4

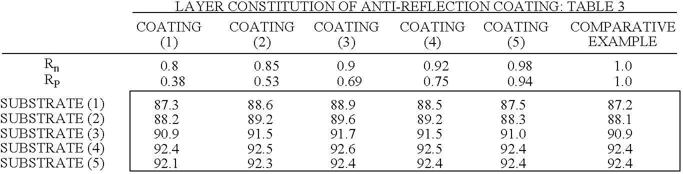

According to the measurement result shown in Table 4, substrates (1) to (4) (NA=0.6 to 0.9) with inventive coating have transmittances larger than those with comparative coating. In particular, substrates (1) to (3) (NA=0.8 to 0.9) show much larger transmittances. These ranges of NA correspond to plane angle ranges of 48 to 72° and 60 to 72° respectively.

Further, substrates (1) to (4) (NA=0.6 to 0.9) show equal or larger transmittance within a range of Rₙ=0.8 to 0.98 (R_{P}=0.38 to 0.94) compared to the comparative example of Rₙ=1.0. In particular, samples having Rₙ=0.85 to 0.92 (R_{P}=0.53 to 0.75) show much larger transmittances.

### EXAMPLE 2

### <Configuration of Objective Lens>

As for the examples of the objective lens 15 of the present invention, five types of the lens substrate 150 each having different NA as shown in table 2 were prepared and the anti-reflection coating 151 composed of two layers as shown in Table 5 was formed on an incident surface of each substrate.

The other conditions were as same as example 1.

TABLE 5

| | | PHYSICAL THICKNESS AT |
|---|---|---|
| LAYER NO. | MATERIAL | CENTER OF LENS (nm) |
| (1) | ZrO₂ | 30 |
| (2) | SiO₂ | 106 |

<Evaluation of Transmittance>

Each of the examples of the objective lens 15, where the lens substrate 150 shown in Table 2 was coated with the anti-reflection coating 151 shown in Table 5 at the incident surface thereof, was measured for transmittance of overall lens. The result of the measurement is shown in an area framed by bold lines of Table 6. In the table, the results are associated with the ratio Rₙ of the refractive index n at the peripheral part D to the refractive index n at the center part C and the corresponding ratio R_{P} of the packing density P.

TABLE 6

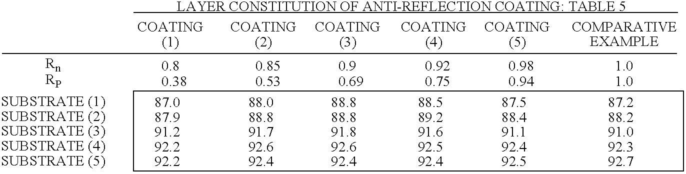

According to the measurement result shown in Table 6, substrates (1) to (4) (NA=0.6 to 0.9) with inventive coating have transmittances almost larger than those with comparative coating. In particular, substrates (1) to (3) (NA=0.8 to 0.9) show much larger transmittances. These ranges of NA correspond to plane angle ranges of 48 to 72° and 60 to 72° respectively.

Further, substrates (1) to (4) (NA=0.6 to 0.9) show larger transmittance almost within an entire range of Rₙ=0.8 to 0.98 (R_{P}=0.38 to 0.94) than the comparative example of Rₙ=1.0. In particular, samples having Rₙ=0.85 to 0.92 (R_{P}=0.53 to 0.75) show completely larger transmittances.

Comparing the measurement result of example 2 with that of example 1, example 1 shows broader range of NA, Rₙ or R_{P} where transmittance of the sample is larger than the comparative example of Rₙ=1.0. Further, example 1 shows larger difference of refractive index to the comparative example of Rₙ=1.0. Therefore, the anti-reflection coating 151 of example 1 composed of three layers is superior to the anti-reflection coating 151 of example 2 composed of two layers in the point of the higher transmittance.

As described above, according to the objective lens 15 of the present invention, the ratio Rₙ of the anti-reflection coating, which is a ratio of the refractive index n at the peripheral part D to the refractive index n at the center part C, is less than 1.0. Thus, it is possible to suppress effectively increase of reflectance of light beam at the peripheral part D so as to improve the transmittance. This advantage may be explained by the following reasons.

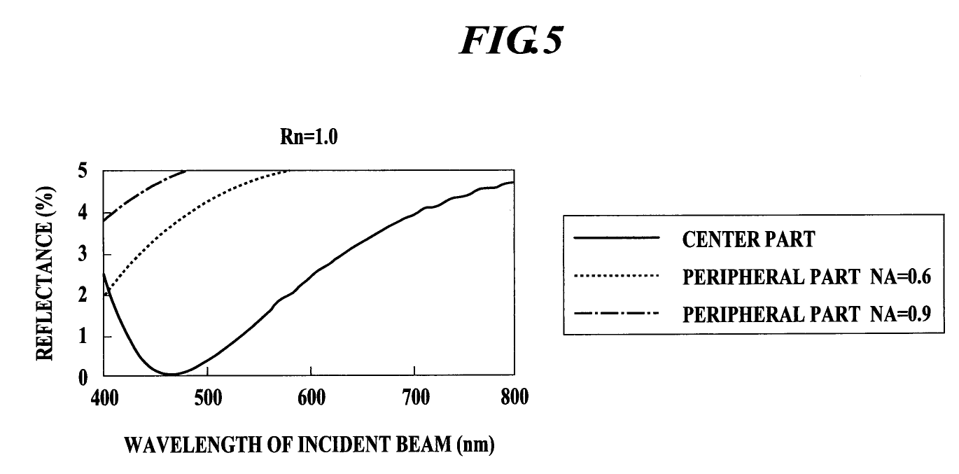

General anti-reflection coating has characteristics of reflectance as shown in FIG. 5, that the curve shifts to lower wavelength while keeping its shape as the NA gets larger. In conventional anti-reflection coating, transmittance of an total lens has been improved based on this characteristics by adjusting the wavelength where minimum transmittance is obtained.

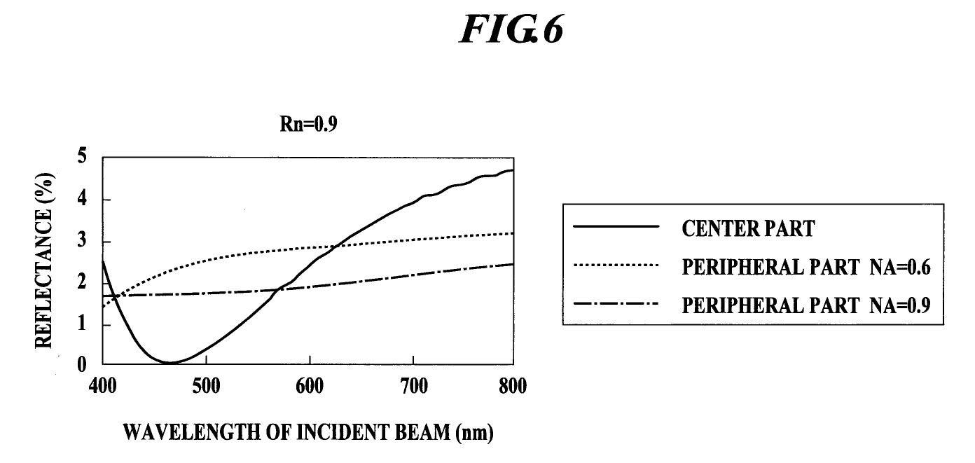

On the other hand, as show in FIG. 6, the anti-reflection coating 151 of the invention has reflectance characteristics of the ratio of the refractive index n at the peripheral part D to the refractive index n at the center part C of Rₙ<1.0 (0.9 in the example show in the figure), so that the refractive index at the peripheral part D where NA is large is suppressed low while the number of layers are kept as many as the prior art. Therefore, it becomes possible to improve total transmittance of the objective lens 15 while the production cost thereof is kept as low as before. FIGS. 5 and 6 show graphs of the anti-reflection coating 151 for BD.

The entire disclosure of Japanese Patent Application No. 2007-127954 filed on May 14, 2007 including description, claims, drawings, and abstract are incorporated herein by reference.

What is claimed is:

1. An objective lens for an optical pickup apparatus which records and/or reproduces information with a light beam emitted from a light source, comprising:
a substrate; and
an anti-reflection coating comprising at least one layer, formed on a surface of the substrate at a side of the light source,
wherein a refractive index of the anti-reflection coating at a peripheral part where an outer edge of an effective light beam transmits is smaller than a refractive index of the anti-reflection coating at a center part where a light beam on an optical axis transmits.

2. An objective lens for an optical pickup apparatus which records and/or reproduces information with a light beam emitted from a light source, comprising:
a substrate; and
an anti-reflection coating comprising at least one layer, formed on a surface of the substrate at a side of the light source,
wherein a packing density of the anti-reflection coating at a peripheral part where an outer edge of an effective light beam transmits is smaller than a packing density of the anti-reflection coating at a center part where a light beam on an optical axis transmits.

3. The objective lens of claim 1, wherein a wavelength λ of the light beam emitted from the light source is within a range of 350 nm≦λ≦450 nm.

4. The objective lens of claim 1, having a numeral aperture of 0.6 to 0.9 inclusive.

5. The objective lens of claim 1, having a numeral aperture of 0.8 to 0.9 inclusive.

6. The objective lens of claim 1, wherein an angle between a normal line of a surface at the peripheral part and the optical axis is 48° to 72° inclusive.

7. The objective lens of claim 6, wherein the angle between the normal line of the surface at the peripheral part and the optical axis is 60° to 72° inclusive.

8. The objective lens of claim 1, wherein the anti-reflection coating is composed of one to three layers.

9. The objective lens of claim 1, wherein at least one layer of the anti-reflection coating is formed of a low-refractive index material having a refractive index n of 1.3≦n≦1.5 for a light of 500 nm wavelength.

10. The objective lens of claim 9, wherein the low-refractive index material is SiO₂-based material.

11. The objective lens of claim 1, wherein the refractive index at the peripheral part is 0.8 to 0.98 times inclusive of the refractive index at the center part.

12. The objective lens of claim 11, wherein the refractive index at the peripheral part is 0.85 to 0.92 times inclusive of the refractive index at the center part.

13. The objective lens of claim 2, wherein the packing density at the peripheral part is 0.38 to 0.94 times inclusive of the packing density at the center part.

14. The objective lens of claim 13, wherein the packing density at the peripheral part is 0.53 to 0.75 times inclusive of the packing density at the center part.

15. The objective lens of claim 1, wherein the substrate is formed of a plastic material.

16. An optical pickup apparatus comprising the objective lens of claim 1.
